(19) United States
(12) Patent Application Publication
(10) Pub. No.: US 2010/0085390 A1
(43) Pub. Date: Apr. 8, 2010

(54) IMAGE DISPLAY APPARATUS

(75) Inventor: Shoshiro Saruta, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/573,001

(22) Filed: Oct. 2, 2009

(30) Foreign Application Priority Data
Oct. 7, 2008 (JP) 2008-260548

(51) Int. Cl. G09G 5/10

(52) U.S. Cl. 345/690; 345/213; 345/75.2

(57) ABSTRACT

A device that carries a panel comprising a back panel with wirings and electron emitting devices provided in intersection portions of the wirings and a face plate with formed therein cells comprising a fluorescent material that emits light, and in which gradation control is performed by varying an application time of a drive voltage that is applied to the electron emitting devices, wherein a line selection time is longer than 1 μs and the fluorescent material comprises a substance represented by a general formula Me₂Si₅N₈:Eu²⁺ (Me is Ca or Sr).

### BACKGROUND OF THE INVENTION

1. Field of the Invention

The present invention relates to an image display apparatus.

2. Related Art

The market of flat panel displays (abbreviated hereinbelow as FPD) using liquid crystals or plasma emission has recently expanded in the field of image display apparatuses. Further, field emission display devices (abbreviated hereinbelow as FED) and surface conduction electron emitting displays (abbreviated hereinbelow as SED) are known as next-generation auto-emission FPD. A SED is described in U.S. Pat. No. 6,179,678.

Basic principles of the aforementioned FED and SED are identical to those of a Brown tube (abbreviated hereinbelow as CRT) and they typically use P22 fluorescent materials that have been successfully used in CRT for a long time, as disclosed in Japanese Patent Laid-Open No. 63-039982.

Japanese Patent Laid-Open No. 2005-060714 discloses a nitride fluorescent material in which B, Al, Cu, Mn, and Mg are contained in basic constituent elements of Ca₂Si₅N₇:Eu and a light-emitting device that uses such a material and has improved emission color.

In FED and SED, the so-called simple matrix drive is used by which electron emitting devices arranged in a matrix shape are linearly successively driven in the y direction. Further, FED and SED are provided with a plurality of scanning wirings and a plurality of modulation wirings arranged in the form of a matrix, and each electron emitting device is connected to one scanning wiring and one modulation wiring. Synchronously with linear and successive driving of the plurality of scanning wirings (a selective voltage is applied successively), a modulation voltage is applied via the modulation wirings to the electron emission element connected to the scanning wiring to which the selective voltage has been applied. In this manner, electron emitting devices arranged in the matrix configuration are simple matrix driven.

A line selection time t (sec) means a maximum allowed time in which each scanning wiring is selected (time in which selective voltage is applied), and this time can be given by the following Equation (1) in which n is the number of scanning wirings, f (Hz) is the frame frequency, and C1 is a constant depending on a drive system.

t=C1/(f·n) (1)

The constant C1 is 1 in a progressive drive system and 2 in an interlace drive system.

A VGA (Video Graphics Array) with a display resolution of 640×480 dots, which is considered to be sufficient for dynamic displays from the standpoint of practical use, will be explained below by way of example.

A line selection time when an interlace drive is used at a lowest frame frequency of 60 Hz at which flicker viewing is prevented in the FED or SED display of such a resolution is about 70 μs at maximum.

A method called a pulse width modulation method by which an application time of a drive voltage (modulation voltage) that is applied to the modulation wiring connected to each electron emitting device is varied within a range of time that can be selected is a typical method for performing gradation representation by using a line progressive drive.

In the progressive drive, the selection time is about half that in the interlace drive and further decreases as the number of scanning wirings increases. In the future, the selection time will decrease as the gradation representation number will increase.

However, a red fluorescent material that is presently used in FED or SED of high and intermediate speed with an accelerating voltage of equal to or higher than 5 kV is typically a red europium-activated yttrium oxysulfide fluorescent material (Y₂O₂S:Eu³⁺, abbreviated hereinbelow as YOS) that proved to be effective in CRT.

A matter associated with this fluorescent material is that the emission delay thereof, as represented by 1/10 decay, is equal to or longer than about 1 ms, and this delay time is much longer than the above-described selection time of line progressive drive, thereby causing degradation of dynamic image display performance due to afterglow visibility.

This matter originates in a 4f4f inner shell transition of Eu³⁺, which is a quantum-mechanical prohibition, and cannot be resolved.

Among the red fluorescent materials that are presently used, none is found to demonstrate sufficient dynamic image display performance that is required for FED and SED.

### SUMMARY OF THE INVENTION

According to an aspect of the present invention, it is provided that the device that carries a panel comprising a back panel with wirings that cross each other and electron emitting devices provided in intersection portions of the wirings and a face plate with formed therein cells comprising fluorescent materials that emit red, blue, and green light, and in which gradation control is performed by varying an application time of a drive voltage that is applied to the electron emitting devices, wherein a line selection time, which is an application time of a drive voltage that is applied to the electron emitting devices via the wirings that cross each other, is longer than 1 μs and a red fluorescent material that forms the cells emitting red light is represented by a general formula Me₂Si₅N₈:Eu²⁺ (Me is Ca or Sr). According to another aspect of the present invention, it is provided that the device that carries a panel comprising a back panel with wirings and electron emitting devices provided in intersection portions of the wirings and a face plate with formed therein cells comprising a fluorescent material that emits light, and in which gradation control is performed by varying an application time of a drive voltage that is applied to the electron emitting devices, wherein a line selection time is longer than 1 μs and the fluorescent material comprises a substance represented by a general formula Me₂Si₅N₈:Eu²⁺ (Me is Ca or Sr). According to another aspect of the present invention, it is provided that a display comprising an electron emitting device and a red fluorescent material which emits red light in response to emission of the electron emitting device, wherein an application time of a drive energy to drive the electron emitting device is longer than a 1/10 luminance decay time of the red fluorescent material.

Further features of the present invention will become apparent from the following description of exemplary embodiments with reference to the attached drawings.

### BRIEF DESCRIPTION OF THE DRAWINGS

FIG. 1 is a perspective view of a FED panel representing an example of the invention.

FIG. 2 is a production flowchart of a fluorescent surface having an aluminum back attached thereto that is used in accordance with the invention.

FIG. 3 shows a black matrix of a face plate used in the embodiment and a comparative example.

### DETAILED DESCRIPTION OF THE VARIOUS EMBODIMENTS

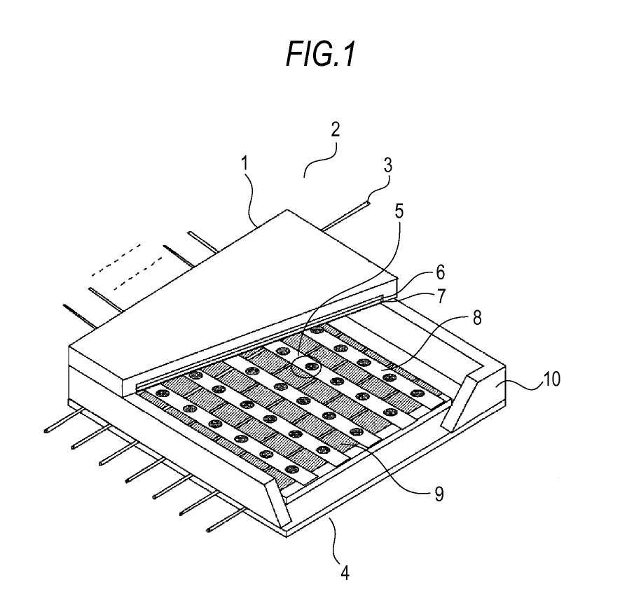

The configuration of a representative FED panel according to the invention will be explained below by using a schematic perspective view shown in FIG. 1. A FED panel 2 is a vacuum air-tight container that can display information such as images.

The FED panel 2 has a thin flat configuration in which an insulating frame 10 serving to maintain a gap between the substrates is inserted and air-tightly sealed between a face plate 1 provided with an aluminum back 7 serving as an anode and a rear plate 4 provided with a cathode.

A fluorescent material layer 6 corresponding to each color of red, green, and blue serving as sub-pixels (not shown in the figure) that form respective dots and an aluminum back 7 are formed in the order of description on the face plate 1, and a high-voltage terminal 3 is then provided for applying a high voltage to the aluminum back 7.

Sub-pixels (not shown in the figure) are usually formed within a region covered with a black material called a black matrix. The aluminum back 7 has a function of removing electrostatic charges located on the fluorescent material and mirror-surface reflecting the emitted light. The aluminum back is connected to the high-voltage terminal 3 and a high voltage is applied to the aluminum back.

Wirings 8 and wirings 9 that cross the wirings 8 are formed at the rear plate 4. The wirings and wirings 9 are typically perpendicular to each other. The wirings 8 and 9 are connected to terminals to which signals are supplied from the outside. Further, in the configuration shown in FIG. 1, an electron emitting device 5 is provided in the crossing point (intersection portion) of the wirings 8 and 9. The crossing point (intersection portion) of the wirings 8 and 9, as referred to herein, not only indicates the intersection portion of a wiring 8 and a wiring 9 by itself, but also includes the vicinity of the intersection portion of the wiring 8 and wiring 9. For example, in the configuration described in U.S. Pat. No. 6,179,678, a large number of wirings extending in the Y direction intersect with a large number of wirings extending in the X direction, and electron emitting devices are provided in the vicinity of the intersection portions. Such a mode is also included in a mode in which an electron emitting device is provided in a crossing point (intersection portion) of two wirings that cross each other. One of the wiring 8 and wiring 9 is a scanning wiring and the other is a modulation wiring.

In the FED panel 2, elements obtained by spint-type deposition of carbon and field emission elements obtained by growing carbon nanotubes (CNT) are used as the electron emitting devices. An image display apparatus that carries the FED panel is called a FED (Field Emission Display).

An image display apparatus that carries a SED panel composed of a face panel and a back panel using surface-conduction electron emitting devices as the aforementioned electron emitting devices is called SED (Surface-conduction Electron-emitter Display).

In the vacuum air-tight container of the display, a vacuum structure is obtained by evacuating to a high-vacuum state via an evacuation tube (not shown in the figure) linked to a vacuum pump and sealing in an appropriate state.

In the FED panel 2 including the vacuum air-tight container of the above-described configuration, electrons are emitted from the electron emitting devices 5 when an accelerating voltage is applied between the rear plate 4 and face plate 1.

In the FED panel 2, image information can be formed on the face plate 1 by causing the emitted electrons to collide with a fluorescent surface and causing the fluorescent surface to emit light. The image is formed by applying a voltage for driving the electron emitting devices to the wiring 8 and scanning the applied voltage with a constant frequency in the scanning wiring direction.

The inventors noticed that the dynamic image display capacity of FED and SED is regulated by a red fluorescent material with a long decay time of fluorescence and discovered a red fluorescent material with a short decay time. A FED panel and a SED panel composed of a face panel and a back panel having electron emitting devices formed thereon will be both referred to hereinbelow simply as “a panel”.

Thus, in a case of an image display apparatus that carries a panel composed of a back panel having wirings that cross each other and electron emitting devices provided in intersection portions of the wirings and a face plate having formed therein cells composed of a red fluorescent material that receives electrons emitted from the electron emitting devices and emits red light, and in which gradation control is performed by varying an application time of a drive voltage that is applied to the electron emitting devices, a line selection time, which is an application time of a drive voltage is to be applied to the electron emitting devices, be longer than 1 μs and that the red fluorescent material be a fluorescent material represented by a general formula Me₂Si₅N₈:Eu²⁺ (Me is Ca or Sr), such as, Ca₂Si₅N₈:Eu²⁺, Sr₂Si₅N₈:Eu²⁺, and (CaSr)Si₅N₈:Eu²⁺. The fluorescent material represented by the general formula Me₂Si₅N₈:Eu²⁺ (Me is Ca or Sr) has a fast 1/10 luminance decay of about 1 μs and, therefore, the dynamic image characteristic can be improved. It may be realized that an application time of a drive energy to drive the electron emitting device is longer than a 1/10 luminance decay time of the red fluorescent material.

This feature originates in a 5d4f reverse-transition emission from a Eu²⁺ emission center.

In a case of an image display apparatus that carries a panel composed of a back panel having wirings that cross each other and electron emitting devices provided in intersection portions of the wirings and a face plate having formed therein cells composed of a red fluorescent material that emits red light, and in which gradation control is performed by varying a time in which a drive voltage is applied to the electron emitting devices,

a first fluorescent material layer and a second fluorescent material layer is to be successively laminated on the face plate and the fluorescent material constituting the first fluorescent material layer be a red fluorescent material that emits red light on receiving light emitted by the second fluorescent material layer that receives electrons emitted from the electron emitting devices,

a fluorescent material that constitutes the first fluorescent material layer and receives light emitted by the second fluorescent material layer that receives electrons emitted from the electron emitting devices is to be a red fluorescent material that emits red light, and

the shortest time from among a selection time, which is a time in which a drive voltage is applied to the electron emitting devices, is to be longer than 1 μs and the fluorescent material constituting the first fluorescent material layer be a fluorescent material represented by a general formula Me₂Si₅N₈:Eu²⁺ (Me is Ca or Sr).

The fluorescent material constituting the second fluorescent material layer may be any fluorescent material, provided that the light emitted thereby on reception of electrons causes red emission from the red fluorescent material constituting the first fluorescent material layer. In this case, the fluorescent material constituting the second fluorescent material layer is a complex alkaline earth silicate fluorescent material represented by a general formula M1ₗM2ₘSi₂O₆:Eu²⁺ (M1, M2 are any of Ba, Sr, Ca, and Mg; 1<l+m<3), or may be CaₗMgₘSi₂O₆:Eu²⁺.

It is further that l+m=2.

In a case where the above-described red fluorescent material layer has a two-layer laminated structure, the Me₂Si₅N₈:Eu²⁺ (Me is Ca or Sr) fluorescent material has strong absorption in a near ultraviolet region to visible region. Therefore, the emission of Me₂Si₅N₈:Eu²⁺ (Me is Ca or Sr) from a region with a low charge density can be increased by forming a second fluorescent material layer that demonstrates efficient emission in this absorption band under electron beam excitation and causing re-absorption of this emission in the Me₂Si₅N₈:Eu²⁺ (Me is Ca or Sr) layer, which is the first fluorescent material layer.

In electron beam excitation with an accelerating voltage of 5-15 kV, the excitation is known to be limited to about less than 1 μm of the fluorescent material surface, but with light excitation, all the emission centers present in the fluorescent material can be excited and, therefore, a higher luminance can be obtained.

In this case, the fluorescent material forming the second fluorescent material layer is a complex alkaline earth silicate fluorescent material represented by a general formula M1ₗM2ₘSi₂O₆:Eu²⁺ (M1, M2 are any of Ba, Sr, Ca, and Mg; 1<l+m<3).

This fluorescent material demonstrates emission in the near ultraviolet to visible region, which is optimum for the Me₂Si₅N₈:Eu²⁺ (Me is Ca or Sr), and has a fast 1/10 luminance decay of about 1 μs. Therefore, a sufficiently fast emission can be also expected with respect to the emission from the Me₂Si₅N₈:Eu²⁺ (Me is Ca or Sr) after re-absorption.

Therefore, in an image display apparatus with such a configuration and a line selection time of longer than 1 μs, the fluorescent material demonstrates sufficient decay within the selection time range and, therefore, the image display apparatus has dynamic image display capability.

When l+m>3 or l+m<1, in a case where an emission shift is generated and emission is observed at a wavelength longer than that absorbed by the Me₂Si₅N₈:Eu²⁺ (Me is Ca or Sr) fluorescent material, undesirable red sub-pixel emission is demonstrated, thereby decreasing color purity. Where the emission wavelength shifts to the shorter wavelengths, the overlapping with the absorption band of Me₂Si₅N₈:Eu²⁺ (Me is Ca or Sr) decreases, and it is impossible to obtain a luminance that is higher than that obtained with only the first fluorescent material layer.

The invention will be explained below in greater details with reference to a comparative example and specific example embodiments thereof.

### Comparative Example

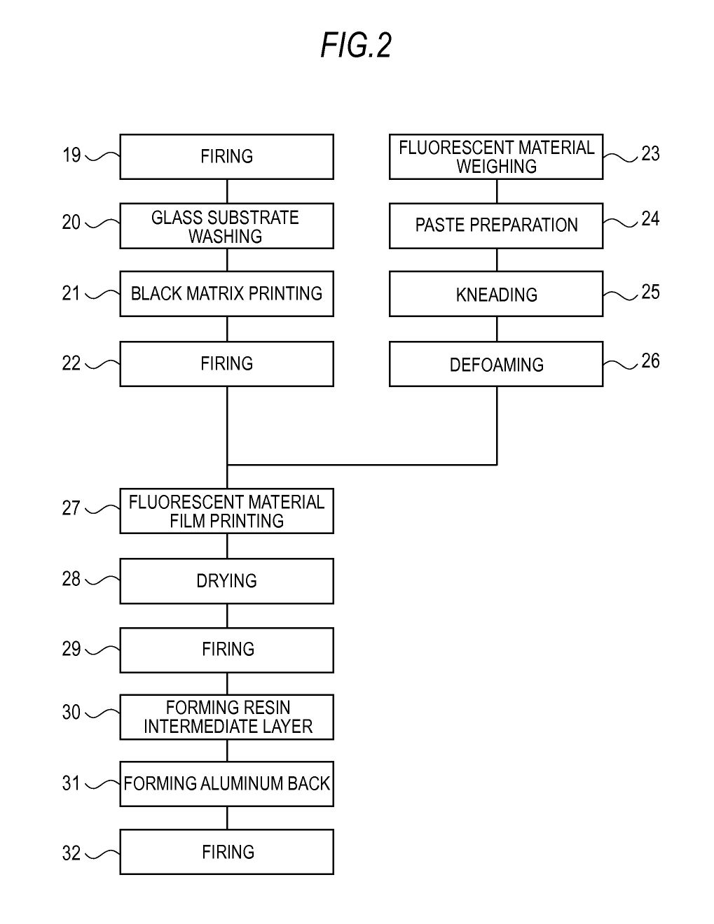

A production flow of a face plate having attached thereto an aluminum back that is implemented in the comparative example is shown in FIG. 2, and the explanation will follow this production flow.

Initially, a firing process 19 was conducted by heating a soda-lime-glass substrate for 1 h at a temperature of 550° C. in the air, and the unnecessary alkali components were caused to precipitate.

A glass substrate washing process 20 was then conducted by cooling the substrate to room temperature, then immersing in an aqueous solution of a neutral detergent, scrub washing, and then through ultrasonic rinsing with pure water and drying.

A screen printing process 21 was then conducted by setting the glass substrate in a screen printing apparatus, using a black pigment paste, and screen printing via a patterned emulsion plate. Another firing process 22 was then conducted by drying and heating for approximately 1 h at a temperature of 550° C. after drying, and a substrate with a black matrix formed thereon was obtained.

In one embodiment, openings with a size of approximately 0.3 mm×0.7 mm were then formed with a pitch of 0.5 in the x direction (1920 openings) and a pitch of approximately 1.5 in the y direction (480 openings) in the patterned black matrix.

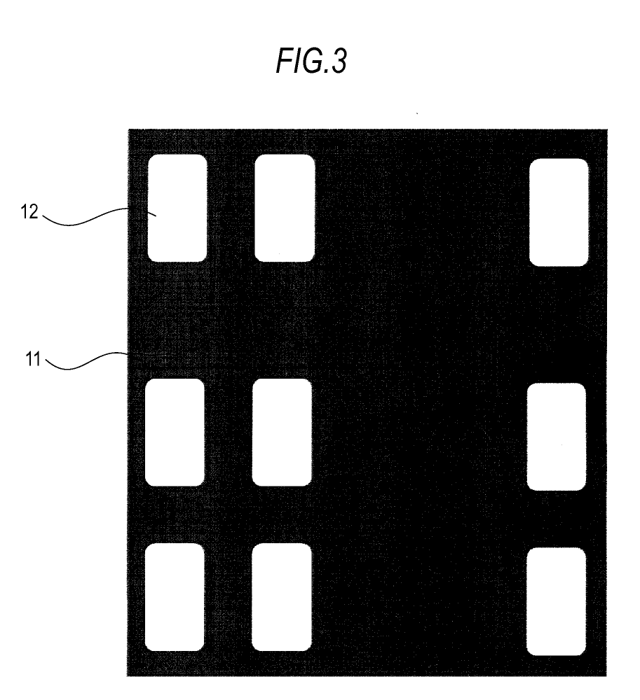

The black matrix is shown in FIG. 3. In FIG. 3, the reference numeral 11 stands for a black matrix portion, and 12 stands for openings for forming fluorescent material subpixel dots.

Fluorescent material stripes were then formed by the below-described method on the glass substrate provided with the black matrix.

First, a fluorescent material weighing process 23 was conducted by placing 100 g of a ZnS:Ag, Cl fluorescent material (trade name P22-B1, manufactured by Kasei Optonix Co., Ltd.) demonstrating blue emission in a Teflon® container equipped with a lid. A paste preparation process 24 was then conducted by adding appropriate amounts of a terpineol solution having ethyl cellulose dissolved therein to a high concentration and terpineol for viscosity adjustment. A kneading process 25 was then conducted with a roll mill device. A defoaming process 26 was then conducted with a planetary stirring device, and a blue fluorescent material paste was obtained.

The glass substrate provided with the black matrix was then again set in a screen printing apparatus, and a fluorescent material film printing process 27 was conducted via a patterned emulsion plate by using the blue fluorescent material paste. A blue fluorescent material stripe layer could be then formed in positions of fluorescent sub-pixel dots via a drying process 28 and a yet another firing process 29.

A ZnS:Cu, Al fluorescent material (trade name P22-GN4, manufactured by Kasei Optonix Co., Ltd.), which demonstrates green emission, and a Y₂O₂S:Eu³⁺ fluorescent material (trade name P22-RE3, manufactured by Kasei Optonix Co., Ltd.), which demonstrates red emission, were then used in a similar manner, and a green fluorescent material stripe layer and a red fluorescent material stripe layer were formed by repeating the processes 23 to 29.

The substrate having the fluorescent material layers of three colors formed thereon was then disposed on a spin coater, the substrate surface was sufficiently wetted with pure water, and at the same time, an aqueous solution of colloidal silica was sprayed with the object of bonding together the fluorescent material particles and bonding the fluorescent material to the glass substrate. A resin intermediate formation process 30 was then conducted by atomizing a toluene solution of an acrylic lacquer.

Then, an aluminum back formation process 31 (forming aluminum back) was conducted in which the substrate was set in an EB vapor deposition apparatus and aluminum was vapor deposited to a thickness of approximately 80 nm. Finally, a firing process 32 was conducted by heating for approximately 1 h at a temperature of 450° C. in the air and the resin intermediate layer was removed.

A face plate equipped with an aluminum back and having a VGA display resolution could thus be obtained.

A rear plate having electron emitting devices formed therein was produced by the following method.

Matrix-shaped wirings corresponding to a VGA display resolution was formed by repeating the Ag paste and insulating paste screen printing, drying, and firing processes on a glass substrate that was washed by the same method as the face plate.

After the wirings have thus been formed, electron emitting devices were formed in the intersection portions. These electron emitting devices are present in positions corresponding to the openings in the face plate. In the present example, the so-called spindt-type configuration was used.

The face plate equipped with the aluminum back and the rear plate were placed opposite each other with a glass circumferential support frame interposed therebetween. The frame had a thickness of 1.6 mm and was coated with a lead frit. An air-tight container was then formed by conducting heating under pressure. The container was connected to an appropriate evacuation system via an evacuation pipe and sufficient evacuation was performed. A FED panel as a vacuum container was then obtained by sealing.

An image display apparatus that carried this FED panel was used as a computer display monitor and connected to a personal computer having Microsoft Windows 2000 installed therein. The system was started and a screen was displayed.

Then, “Message Board Display” of screen saver was selected, red color was set as a background, and a word “Recognize” was set to be displayed in a white bold font with a size 144 in an MS theme font.

The speed was then adjusted so that the word moved from the right to the left in 2 sec.

The screen of the screen saver was shown from the same position to 100 arbitrarily selected people and unattractiveness of the text was investigated in a case where the line selection time was changed as 70 μs, 35 μs, 2 μs, and 1 μs, by changing the frame frequency.

The result of investigation demonstrated that at a frame frequency of 70 μs, two people felt the text to be unattractive, at a frame frequency of 35 μs, 56 people felt the same, and at frame frequencies of 2 μs and 1 μs, all the people felt the text to be unattractive, and the dynamic image visibility performance was judged to be insufficient.

The results are shown in Table 1.

An operation driver for the test was then connected to the FED panel, the accelerating voltage was set to 10 kV, the drive voltage was set so that the electron emitting devices emitted a current of 20 mA/cm², and monochromatic red color was displayed in a progressive drive with a frame frequency of 60 Hz. The selection time in this case was 70 μs.

A radiance meter (SR-3, manufactured by TOPCON Co.) was then disposed in a position at a distance of 0.4 m from a face plate of the FED panel. The pulse width of the drive voltage was then adjusted to be variable within a range of from 2 μs to 20 μs, the luminance Lv was plotted against the pulse width Pw, and regression was conducted by the Equation (2) shown below.

Lv=C2·Pwδ (2)

Here, C2 and δ are constants.

δ is a value showing the linearity of luminance against the pulse width. In the present comparative example, a value of δ=0.85 was obtained, and it is clear that the linearity of luminance against the pulse width is insufficient.

Further, CIE chromaticity and luminance at a pulse width of 20 μs were measured. The luminance obtained in this case was taken as 100 (relative luminance value 100) and compared with the luminance in embodiments. The chromaticity was (x, y)=(0.657, 0.336).

The relative luminance value is listed in Table 1.

The pulse width was then fixed to 20 μs, the drive voltage was adjusted so that the current destiny varied between 1 mA/cm² and 40 mA/cm², the luminance Lv was plotted against the current density Je, and regression was conducted by the Equation (3) shown below.

Lv=C3·Jeγ (3)

Here, C3 and γ are constants.

γ is a value showing the linearity of luminance against the current density. In the present comparative example, a value of γ=0.7 was obtained, and it is clear that the linearity of luminance against the current density is insufficient.

Further, the current density was fixed at 20 mA/cm², the pulse width of the drive voltage was adjusted so that the luminance became 100 cd/m², and when continuous operation was conducted for 10,000 h, the luminance retention ratio was found to exceed 95% sufficiently.

### Example 1

A FED panel was obtained by a method similar to that of the comparative example. The stripes of the red sub-pixels were formed by using a Sr₂Si₅N₈:Eu²⁺ fluorescent material (can be referred to hereinbelow as Sr258) and conducting screen printing by using a paste prepared by a method similar to that of the comparative example.

The synthesis of Sr258 followed the procedure described below.

First, Eu metal grains were placed in a planetary ball mill under a 5% H₂/N₂ atmosphere, sufficiently ground using agate beads with a diameter of 1 mm, and taken out under a glove box in a 5% H₂/N₂ atmosphere.

The ground Eu metal grains were then placed into a BN crucible and introduced in a vacuum tubular furnace, followed by evacuation. High-purity EuN was then obtained by heating for 4 h at a temperature of 600° C., while causing ammonia gas to flow inside the tube at a flow rate of 2 L/min.

The EuN was then taken out in a glove box under a nitrogen atmosphere, SrBr₂ and Si₃N₄ were mixed to respective stoichiometric ratios and mixing and grinding was conducted in an agate mortar. The mixture was then sealed as is in a BN crucible.

The sealed BN crucible was then sealed in a larger BN crucible and a double-wall crucible structure was obtained to avoid exposure to oxygen.

The crucible was placed in a high-pressure sintering furnace and evacuated. Heating to a temperature of 1600° C. was then conducted at a rate of 600° C./h, while maintaining a nitrogen atmosphere under a pressure of 9.5 atm, the attained temperature was maintained for 7 h, and then gradual cooling was conducted to room temperature.

The sample mixture thus obtained was irradiated with black light, non-emitting formations present on the surface were removed, and the product was ground thoroughly in an agate mortar.

The synthesized Sr258 fluorescent material had a deep-orange body color, and the structure thereof was confirmed by powder X-ray diffraction.

The concentrations of Sr and Si were identified by emission spectroscopic analysis and it was confirmed that a composition thereof was Sr₂Si₅N₈:Eu²⁺, provided that in the synthesis, the concentration of Eu²⁺ was 3 wt. %.

The particle size of the Sr258 fluorescent material was measured by a laser diffraction method, and a central value of particle size distribution was 4.9 μm.

The image display apparatus that carried the FED panel obtained in the above-described manner was used as a computer display monitor and connected to a personal computer in the same manner as in the comparative example to investigate the unattractiveness of text.

In the present embodiment, at a selection time of 35 μs and 75 μs, the number of people who felt the text to be unattractive was zero. At a selection time of 2 μs, one person felt the text to be unattractive, and at the selection time of 1 μs, this number was 23. It is clear, that excellent dynamic image visibility was demonstrated at a selection time longer than 1 μs.

The results are presented in Table 1.

When δ was found the result was δ=1, and the linearity of luminance against the pulse width was excellent.

When γ was found in the same manner as in the comparative example, the result was γ=1, and the linearity of luminance against the current density was also excellent.

The luminance and CIE chromaticity were also measured under the same conditions as in the comparative example. The relative luminance value was 65 and the CIE chromaticity was (x, y)=(0.655, 0.340). Thus, the color purity was practically the same as in the comparative example.

These values are shown in Table 1.

Because the luminance excelled in linearity against the current density, the luminance was superior to that in the comparative example at a current density of Je=27 mA/cm².

The continuous drive was also conducted under the conditions identical to those in the comparative example in this state. The luminance retention ratio in this case sufficiently exceeded 95% of the initial luminance.

The time in which the luminance decreased to 1/10 its value was measured by the same method as in the comparative example. The decay time was about 1 μs.

### Example 2

Calcium carbonate, magnesium oxide, and silicon oxide were weighed according to the stoichiometric composition and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain a CaₗMgₘSi₂O₆:Eu²⁺ fluorescent material. The values of l and m could be adjusted with chemical compositions of raw materials charged and three compositions with l+m=1.0, 2.0, and 3.0 were synthesized.

Similarly to the comparative example, these CaₗMgₘSi₂O₆:Eu²⁺ fluorescent materials of three types were converted into pastes by the same method as in the comparative example that is illustrated by processes 23 to 26 in FIG. 2.

A FED panel was produced for each combination of l+m by the same method as in the comparative example.

A red subpixel was produced by using a Sr258 fluorescent material paste similar to that of Example 1 to form stripes and then overlay printing by using the CaₗMgₘSi₂O₆:Eu²⁺ fluorescent material and repeating the processes 27 to 29 shown in FIG. 2 to obtain a two-layer fluorescent structure.

In this case, the CaₗMgₘSi₂O₆:Eu²⁺ fluorescent material was formed on the electron emitting device side on the Sr258 fluorescent material.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, one person when l+m=2, and zero people when l+m=3. At a selection time of 1 μs, the text was felt to be unattractive by 31 people when l+m=1, 28 people when l+m=2, and 24 people when l+m=3. As a result, it is clear that excellent dynamic image visibility was attained at a selection time of more than 1 μs.

The results are presented in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 59 when l+m=1, 121 when l+m=2, and 62 when l+m=3. It is clear that when l+m=2, the luminance was higher than that of the comparative example and Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.654, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 3

Strontium carbonate, magnesium oxide, and silicon oxide were used as starting materials, weighed according to the stoichiometric composition by the same method as in Example 2, and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain SrₗMgₘSi₂O₆:Eu²⁺ fluorescent materials of three types with l+m=1.0, 2.0, and 3.0 wherein the values of l and m could be adjusted with chemical composition of raw materials charged.

These SrₗMgₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, two people when l+m=2, and zero people when l+m=3. At a selection time of 1 μs, the text was felt to be unattractive by 27 people when l+m=1, 27 people when l+m=2, and 36 people when l+m=3. As a result, it is clear that excellent dynamic image visibility was attained at a selection time of more than 1 μs.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 30 when l+m=1, 70 when l+m=2, and 39 when l+m=3. It is clear that when l+m=2, the luminance obtained was higher than that of Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.655, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 4

Barium carbonate, magnesium oxide, and silicon oxide were used as starting materials, weighed according to the stoichiometric composition by the same method as in Example 2, and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain BaₗMgₘSi₂O₆:Eu²⁺ fluorescent materials of three types with l+m=1.0, 2.0, and 3.0.

These BaₗMgₘSi₂O₆:Eu²⁺ fluorescent materials of three types were converted into pastes by the same method as in the comparative example and used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one person when l+m=3. At a selection time of 1 μs, the text was felt to be unattractive by 33 people when l+m=1, 32 people when l+m=2, and 28 people when l+m=3. As a result, it is clear that excellent dynamic image visibility was attained at a selection time of more than 1 μs.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 55 when l+m=1, 105 when l+m=2, and 60 when l+m=3. It is clear that when l+m=2, the luminance was higher than that of the comparative example and Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.654, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 5

Strontium carbonate, magnesium oxide, and silicon oxide were used as starting materials and SrₗCaₘSi₂O₆:Eu²⁺ fluorescent materials of three types with l+m=1.0, 2.0, and 3.0 were synthesized by the same method as in Example 2.

These SrₗCaₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and zero people when l+m=3. At a selection time of 1 μs, the text was felt to be unattractive by 28 people when l+m=1, 25 people when l+m=2, and 29 people when l+m=3. As a result, it is clear that excellent dynamic image visibility was attained at a selection time of more than 1 μs.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 40 when l+m=1, 72 when l+m=2, and 37 when l+m=3. It is clear that when l+m=2, the luminance obtained was higher than that of Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.655, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 6

Barium carbonate, calcium carbonate, and silicon oxide were used as starting materials and BaₗCaₘSi₂O₆:Eu²⁺ fluorescent materials of three types with l+m=1.0, 2.0, and 3.0 were synthesized by the same method as in Example 2.

These BaₗCaₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, one person when l+m=2, and two people when l+m=3. At a selection time of 1 μs, the text was felt to be unattractive by 30 people when l+m=1, 29 people when l+m=2, and 27 people when l+m=3. As a result, it is clear that excellent dynamic image visibility was attained at a selection time of more than 1 μs.

The results are shown in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 38 when l+m=1, 76 when l+m=2, and 57 when l+m=3. It is clear that when l+m=2, the luminance obtained was higher than that of Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.654, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the x+y value.

The time in which the luminance decreased to 1/10 its value was measured by the same method as in the comparative example. The decay time was about 1.5 μs.

### Example 7

Barium carbonate, strontium carbonate, and silicon oxide were used as starting materials and BaₗSrₘSi₂O₆:Eu²⁺ fluorescent materials of three types with l+m=1.0, 2.0, and 3.0 were synthesized by the same method as in Example 2.

These BaₗSrₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and zero people when l+m=3. At a selection time of 1 μs, the text was felt to be unattractive by 21 people when l+m=1, 31 people when l+m=2, and 29 people when l+m=3. As a result, it is clear that excellent dynamic image visibility was attained at a selection time of more than 1 μs.

The results are shown in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 36 when l+m=1, 75 when l+m=2, and 55 when l+m=3. It is clear that when l+m=2, the luminance obtained was higher than that of Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.655, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 8

A FED panel was obtained by the same method as in the comparative example. Stripes of red subpixels were formed by screen printing a paste obtained by the same method as in the comparative example by using a Ca₂Si₅N₈:Eu²⁺ fluorescent material (can be referred to hereinbelow as Ca258). The synthesis of Ca258 followed the procedure described below.

First, Eu metal grains were placed in a planetary ball mill under a 5% H₂/N₂ atmosphere, sufficiently ground using agate beads with a diameter of 1 mm, and taken out under a glove box in a 5% H₂/N₂ atmosphere.

The ground Eu metal grains were then placed into a BN crucible and introduced in a vacuum tubular furnace, followed by evacuation. High-purity EuN was then obtained by heating for 4 h at a temperature of 600° C., while causing ammonia gas to flow inside the tube at a flow rate of 2 L/min.

The EuN was then taken out in a glove box under a nitrogen atmosphere, Ca₃N₂ and Si₃N₄ were mixed to respective stoichiometric ratios and mixing and grinding was conducted in an agate mortar. The mixture was then sealed as is in a BN crucible.

The sealed BN crucible was then sealed in a larger BN crucible and a double-wall crucible structure was obtained to avoid exposure to oxygen.

The crucible was placed in a high-pressure sintering furnace and evacuated. Heating to a temperature of 1500° C. was then conducted at a rate of 600° C./h, while maintaining a nitrogen atmosphere under a pressure of 9.5 atm, the attained temperature was maintained for 7 h, and then gradual cooling was conducted to room temperature.

The sample mixture thus obtained was irradiated with black light, non-emitting formations present on the surface were diligently removed, and the product was finally ground thoroughly in an agate mortar.

The synthesized Ca258 fluorescent material had a deep-orange body color, and the structure thereof was confirmed by powder X-ray diffraction. The concentrations of Sr and Si were identified by emission spectroscopic analysis and a composition of Ca₂Si₅N₈:Eu²⁺ was confirmed.

The synthesis was conducted to obtain 3 wt. % Eu²⁺.

The particle size of Ca258 was measured by a laser diffraction method, and a central value of particle size distribution was 4.9 μm.

The image display apparatus that carried the FED panel obtained in the above-described manner was used as a computer display monitor and connected to a personal computer in the same manner as in the comparative example to investigate the unattractiveness of text.

In the present embodiment, at a selection time of 2 μs, 35 μs, and 75 μs, the number of people who felt the text to be unattractive was zero. At a selection time of 1 μs, 31 people felt the text to be unattractive. As a result, it is clear that excellent dynamic image visibility was attained at a selection time of more than 1 μs.

The results are shown in Table 1.

When δ was found in the same manner as in the comparative example, the result was δ=1, and the linearity of luminance against the pulse width was excellent.

When γ was found in the same manner as in the comparative example, the result was γ=1, and the linearity of luminance against the current density was also excellent.

The luminance and CIE chromaticity were also measured under the same conditions as in the comparative example. The relative luminance value was 58, the CIE chromaticity was (x, y)=(0.650, 0.340), and color purity almost identical to that of the comparative example was demonstrated.

Because the luminance excelled in linearity against the current density, the luminance was superior to that in the comparative example at a current density of Je=27 mA/cm².

The continuous drive was also conducted under the conditions identical to those in the comparative example in this state. The luminance retention ratio in this case sufficiently exceeded 95% of the initial luminance.

The time in which the luminance decreased to 1/10 its value was measured by the same method as in the comparative example. The decay time was about 1.5 μs.

### Example 9

Calcium carbonate, magnesium oxide, and silicon oxide were weighed according to the stoichiometric composition and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain a CaₗMgₘSi₂O₆:Eu²⁺ fluorescent material. The values of l and m could be adjusted with chemical compositions of raw materials charged and three compositions with l+m=1.0, 2.0, and 3.0 were synthesized.

Similarly to the comparative example, these CaₗMgₘSi₂O₆:Eu²⁺ fluorescent materials of three types were converted into pastes by the same method as in the comparative example that is illustrated by processes 23 to 26 in FIG. 2.

A FED panel was produced for each combination of l+m by the same method as in the comparative example.

A red subpixel was produced by using a Ca258 fluorescent material paste similar to that of Example 8 to form stripes and then overlay printing by using the CaₗMgₘSi₂O₆:Eu²⁺ fluorescent material and repeating the processes 27 to 29 shown in FIG. 2 to obtain a two-layer fluorescent structure.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one people when l+m=3. At a selection time of 1 μs, the text was felt to be unattractive by 32 people when l+m=1, 31 people when l+m=2, and 30 people when l+m=3. As a result, it is clear that excellent dynamic image visibility was attained at a selection time of more than 1 μs.

The results are presented in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 56 when l+m=1, 109 when l+m=2, and 54 when l+m=3. It is clear that when l+m=2, the luminance was higher than that of the comparative example and Example 8.

By contrast, when l+m=1 and l+m=3, the luminance was lower than that in Example 8, and the effect of two-layer fluorescent layer material layer configuration was not demonstrated.

These values are shown in Table 1.

The CIE chromaticity was (x, y)=(0.654, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 10

Strontium carbonate, magnesium oxide, and silicon oxide were used as starting materials, weighed according to the stoichiometric composition by the same method as in Example 2, and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain SrₗMgₘSi₂O₆:Eu²⁺ fluorescent materials of three types with l+m=1.0, 2.0, and 3.0.

The values of l and m could be adjusted with chemical compositions of raw materials charged and materials of three types with l+m=1.0, 2.0, and 3.0 were synthesized.

These SrₗMgₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one person when l+m=3. At a selection time of 1 μs, the text was felt to be unattractive by 29 people when l+m=1, 27 people when l+m=2, and 35 people when l+m=3. As a result, it is clear that excellent dynamic image visibility was attained at a selection time of more than 1 μs.

The results are shown in FIG. 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 21 when l+m=1, 60 when l+m=2, and 37 when l+m=3. It is clear that when l+m=2, the luminance obtained was higher than that of Example 1.

By contrast, when l+m=1 and l+m=3, the luminance was lower than that in Example 8, and the effect of two-layer fluorescent layer material layer configuration was not demonstrated.

These values are shown in Table 1.

The CIE chromaticity was (x, y)=(0.655, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 11

Barium carbonate, magnesium oxide, and silicon oxide were used as starting materials, weighed according to the stoichiometric composition by the same method as in Example 2, and thoroughly ground in an agate mortar. Then, europium chloride was added to obtain a Eu content ratio of 3 wt. %, and the components were further thoroughly ground in the agate mortar. The mixture was then dispersed in a beaker filled with pure water, stirred for 24 h with a magnetic stirrer, filtered, and dried to prepare a precursor.

The precursor was placed in an alumina crucible with a capacity of 60 cc and fired for 2 h at a temperature of 1350° C. in the air by using an electric furnace.

Upon firing, the fired product was taken out of the alumina crucible and thoroughly ground in an agate mortar. The ground product was again placed in an alumina crucible, the alumina crucible was placed in an alumina crucible with a capacity of 200 cc, activated carbon was loaded on the circumference, and a double-wall crucible was obtained.

The double-wall crucible was placed in an electric furnace and fired for 2 h at a temperature of 1200° C. in a reducing atmosphere under a flow of 5% H₂/N₂ at a rate of 1 L/min.

Upon firing, the fired product was taken out of the alumina crucible, placed into a beaker, while sieving with water through 100 mesh Nylon, the beaker was filled with pure water, and thorough stirring was conducted with a magnetic stirrer. The mixture was allowed to stay, and washing aimed to remove the supernatant was repeated five times.

Subsequent filtration and drying made it possible to obtain BaₗMgₘSi₂O₆:Eu²⁺ fluorescent materials of three types with l+m=1.0, 2.0, and 3.0.

These BaₗMgₘSi₂O₆:Eu²⁺ fluorescent materials of three types were converted into pastes by the same method as in the comparative example and used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one person when l+m=3. At a selection time of 1 μs, the text was felt to be unattractive by 34 people when l+m=1, 33 people when l+m=2, and 32 people when l+m=3. As a result, it is clear that excellent dynamic image visibility is attained when the selection time is more than 1 μs.

The results are shown in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 55 when l+m=1, 98 when l+m=2, and 50 when l+m=3. It is clear that when l+m=2, the luminance was higher than that of the comparative example and Example 1.

By contrast, when l+m=1 and l+m=3, the luminance was lower than that in Example 1, and the effect of two-layer fluorescent layer material layer configuration was not demonstrated.

These values are shown in Table 1.

The CIE chromaticity was (x, y)=(0.655, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 12

Strontium carbonate, calcium carbonate, and silicon oxide were used as starting materials and SrₗCaₘSi₂O₆:Eu²⁺ fluorescent materials of three types with l+m=1.0, 2.0, and 3.0 were synthesized by the same method as in Example 2.

These SrₗCaₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one person when l+m=3. At a selection time of 1 μs, the text was felt to be unattractive by 28 people when l+m=1, 26 people when l+m=2, and 25 people when l+m=3. As a result, it is clear that excellent dynamic image visibility was attained at a selection time of more than 1 μs.

The results are shown in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 24 when l+m=1, 63 when l+m=2, and 33 when l+m=3. It is clear that when l+m=2, the luminance obtained was higher than that of Example 1.

By contrast, when l+m=1 and l+m=3, the luminance was lower than that in Example 8, and the effect of two-layer fluorescent layer material layer configuration was not demonstrated.

These values are also shown in Table 1.

The CIE chromaticity was (x, y)=(0.654, 0.339), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 13

Barium carbonate, calcium carbonate, and silicon oxide were used as starting materials and BaₗCaₘSi₂O₆:Eu²⁺ fluorescent materials of three types with l+m=1.0, 2.0, and 3.0 were synthesized by the same method as in Example 2.

These BaₗCaₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by one person when l+m=1, zero people when l+m=2, and two people when l+m=3. At a selection time of 1 μs, the text was felt to be unattractive by 29 people when l+m=1, 28 people when l+m=2, and 26 people when l+m=3. As a result, it is clear that excellent dynamic image visibility was attained at a selection time of more than 1 μs.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 35 when l+m=1, 71 when l+m=2, and 52 when l+m=3. It is clear that when l+m=2, the luminance obtained was higher than that of Example 8.

By contrast, when l+m=1 and l+m=3, the luminance was lower than that in Example 1, and the effect of two-layer fluorescent layer material layer configuration was not demonstrated. These values are also shown in Table 1.

The CIE chromaticity was (x, y)=(0.650, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

### Example 14

Barium carbonate, strontium carbonate, and silicon oxide were used as starting materials and BaₗSrₘSi₂O₆:Eu²⁺ fluorescent materials of three types with l+m=1.0, 2.0, and 3.0 were synthesized by the same method as in Example 2.

These BaₗSrₘSi₂O₆:Eu²⁺ fluorescent materials of three types were used to produce FED panels with red subpixels having a two-layer fluorescent material structure by the same method as in Example 2.

Image display apparatuses carrying the FED panels of three types with different l+m values that were obtained in the above-described manner were connected as computer display monitors to personal computers in the same manner as in the comparative example, and unattractiveness of text was investigated.

In the present embodiment, at a selection time of 35 μs and 75 μs, the number of people that felt the text to be unattractive was zero, regardless of the l+m value. At a selection time of 2 μs, the text was felt to be unattractive by zero people when l+m=1, zero people when l+m=2, and one person when l+m=3. At a selection time of 1 μs, the text was felt to be unattractive by 34 people when l+m=1, 31 people when l+m=2, and 30 people when l+m=3. As a result, it is clear that excellent dynamic image visibility is attained when the selection time is more than 1 μs.

The results are shown in Table 1.

When δ was found in the same manner as in the comparative example, the result was δ=1, regardless of the l+m value, and the linearity of luminance against the pulse width was excellent.

When γ was found in the same manner as in the comparative example, the result was γ=1, regardless of the l+m value, and the linearity of luminance against the current density was also excellent.

The luminance and CIE chromaticity were also measured under the same conditions as in the comparative example. The relative luminance value was 31 when l+m=1, 69 when l+m=2, and 52 when l+m=3. It is clear that when l+m=2, the luminance obtained was higher than that of Example 8.

By contrast, when l+m=1 and l+m=3, the luminance was lower than that in Example 1, and the effect of two-layer fluorescent layer material layer configuration was not demonstrated.

These values are also shown in Table 1.

The CIE chromaticity was (x, y)=(0.655, 0.340), regardless of the l+m value, and color purity almost identical to that of the comparative example was demonstrated.

The continuous drive was then conducted in this state under conditions identical to those in the comparative example. The luminance retention ratio in this case sufficiently exceeded 95% of the initial luminance, regardless of the l+m value.

The time in which the luminance decreased to 1/10 its value was measured by the same method as in the comparative example. The decay time was about 1.5 μs.

As described hereinabove, with the image display apparatus in accordance with the embodiment, it is possible to realize a red subpixel that has excellent linearity of luminance against current density and fast luminance decay and, therefore, excellent dynamic image reproducibility and gradation display ability, and also has good color purity and excellent service life.

The examples and comparative example use image display apparatuses carrying a FED panel, but the same results can be also obtained with the image display apparatus carrying a SED panel.

TABLE 1

| | | | | Number of people (among 100 people) who | | | | Luminance when |
|---|---|---|---|---|---|---|---|---|
| | | | | felt the text to be unattractive | | | | comparative |
| | Fluorescent configuration of red subpixel | | | Selection time | Selection time | Selection time | Selection time | example is |
| | First layer | Second layer | | t = 1 μs | t = 2 μs | t = 35 μs | t = 70 μs | taken as 100 |
| Comparative | Y₂O₂S: Eu³⁺ | None | | 100 | 100 | 56 | 2 | 100 |
| example | | | | | | | | |
| Example 1 | Sr₂Si₅N₈: Eu²⁺ | None | | 23 | 1 | 0 | 0 | 65 |
| Example 2 | Sr₂Si₅N₈: Eu²⁺ | CaₗMgₘSi₂O₆: Eu²⁺ | l + m = 1 | 31 | 0 | 0 | 0 | 59 |
| | Sr₂Si₅N₈: Eu²⁺ | CaₗMgₘSi₂O₆: Eu²⁺ | l + m = 2 | 28 | 1 | 0 | 0 | 121 |
| | Sr₂Si₅N₈: Eu²⁺ | CaₗMgₘSi₂O₆: Eu²⁺ | l + m = 3 | 24 | 0 | 0 | 0 | 62 |
| Example 3 | Sr₂Si₅N₈: Eu²⁺ | SrₗMgₘSi₂O₆: Eu²⁺ | l + m = 1 | 27 | 0 | 0 | 0 | 30 |
| | Sr₂Si₅N₈: Eu²⁺ | SrₗMgₘSi₂O₆: Eu²⁺ | l + m = 2 | 27 | 2 | 0 | 0 | 70 |
| | Sr₂Si₅N₈: Eu²⁺ | SrₗMgₘSi₂O₆: Eu²⁺ | l + m = 3 | 36 | 0 | 0 | 0 | 39 |
| Example 4 | Sr₂Si₅N₈: Eu²⁺ | BaₗMgₘSi₂O₆: Eu²⁺ | l + m = 1 | 33 | 0 | 0 | 0 | 55 |
| | Sr₂Si₅N₈: Eu²⁺ | BaₗMgₘSi₂O₆: Eu²⁺ | l + m = 2 | 32 | 0 | 0 | 0 | 105 |
| | Sr₂Si₅N₈: Eu²⁺ | BaₗMgₘSi₂O₆: Eu²⁺ | l + m = 3 | 28 | 1 | 0 | 0 | 60 |
| Example 5 | Sr₂Si₅N₈: Eu²⁺ | SrₗCaₘSi₂O₆: Eu²⁺ | l + m = 1 | 28 | 0 | 0 | 0 | 40 |
| | Sr₂Si₅N₈: Eu²⁺ | SrₗCaₘSi₂O₆: Eu²⁺ | l + m = 2 | 25 | 0 | 0 | 0 | 72 |
| | Sr₂Si₅N₈: Eu²⁺ | SrₗCaₘSi₂O₆: Eu²⁺ | l + m = 3 | 29 | 0 | 0 | 0 | 37 |
| Example 6 | Sr₂Si₅N₈: Eu²⁺ | BaₗCaₘSi₂O₆: Eu²⁺ | l + m = 1 | 30 | 0 | 0 | 0 | 38 |
| | Sr₂Si₅N₈: Eu²⁺ | BaₗCaₘSi₂O₆: Eu²⁺ | l + m = 2 | 29 | 1 | 0 | 0 | 76 |
| | Sr₂Si₅N₈: Eu²⁺ | BaₗCaₘSi₂O₆: Eu²⁺ | l + m = 3 | 27 | 2 | 0 | 0 | 57 |
| Example 7 | Sr₂Si₅N₈: Eu²⁺ | BaₗSrₘSi₂O₆: Eu²⁺ | l + m = 1 | 21 | 0 | 0 | 0 | 36 |
| | Sr₂Si₅N₈: Eu²⁺ | BaₗSrₘSi₂O₆: Eu²⁺ | l + m = 2 | 31 | 0 | 0 | 0 | 75 |
| | Sr₂Si₅N₈: Eu²⁺ | BaₗSrₘSi₂O₆: Eu²⁺ | l + m = 3 | 29 | 0 | 0 | 0 | 55 |
| Example 8 | Ca₂Si₅N₈: Eu²⁺ | None | | 31 | 0 | 0 | 0 | 58 |
| Example 9 | Ca₂Si₅N₈: Eu²⁺ | CaₗMgₘSi₂O₆: Eu²⁺ | l + m = 1 | 32 | 0 | 0 | 0 | 56 |
| | Ca₂Si₅N₈: Eu²⁺ | CaₗMgₘSi₂O₆: Eu²⁺ | l + m = 2 | 31 | 0 | 0 | 0 | 109 |
| | Ca₂Si₅N₈: Eu²⁺ | CaₗMgₘSi₂O₆: Eu²⁺ | l + m = 3 | 30 | 1 | 0 | 0 | 54 |
| Example 10 | Ca₂Si₅N₈: Eu²⁺ | SrₗMgₘSi₂O₆: Eu²⁺ | l + m = 1 | 29 | 0 | 0 | 0 | 21 |
| | Ca₂Si₅N₈: Eu²⁺ | SrₗMgₘSi₂O₆: Eu²⁺ | l + m = 2 | 27 | 0 | 0 | 0 | 60 |
| | Ca₂Si₅N₈: Eu²⁺ | SrₗMgₘSi₂O₆: Eu²⁺ | l + m = 3 | 35 | 1 | 0 | 0 | 37 |
| Example 11 | Ca₂Si₅N₈: Eu²⁺ | BaₗMgₘSi₂O₆: Eu²⁺ | l + m = 1 | 34 | 0 | 0 | 0 | 55 |
| | Ca₂Si₅N₈: Eu²⁺ | BaₗMgₘSi₂O₆: Eu²⁺ | l + m = 2 | 33 | 0 | 0 | 0 | 98 |
| | Ca₂Si₅N₈: Eu²⁺ | BaₗMgₘSi₂O₆: Eu²⁺ | l + m = 3 | 32 | 1 | 0 | 0 | 50 |
| Example 12 | Ca₂Si₅N₈: Eu²⁺ | SrₗCaₘSi₂O₆: Eu²⁺ | l + m = 1 | 28 | 0 | 0 | 0 | 24 |
| | Ca₂Si₅N₈: Eu²⁺ | SrₗCaₘSi₂O₆: Eu²⁺ | l + m = 2 | 26 | 0 | 0 | 0 | 63 |
| | Ca₂Si₅N₈: Eu²⁺ | SrₗCaₘSi₂O₆: Eu²⁺ | l + m = 3 | 25 | 1 | 0 | 0 | 33 |
| Example 13 | Ca₂Si₅N₈: Eu²⁺ | BaₗCaₘSi₂O₆: Eu²⁺ | l + m = 1 | 29 | 1 | 0 | 0 | 35 |
| | Ca₂Si₅N₈: Eu²⁺ | BaₗCaₘSi₂O₆: Eu²⁺ | l + m = 2 | 28 | 0 | 0 | 0 | 71 |
| | Ca₂Si₅N₈: Eu²⁺ | BaₗCaₘSi₂O₆: Eu²⁺ | l + m = 3 | 26 | 2 | 0 | 0 | 52 |
| Example 14 | Ca₂Si₅N₈: Eu²⁺ | BaₗSrₘSi₂O₆: Eu²⁺ | l + m = 1 | 34 | 0 | 0 | 0 | 31 |
| | Ca₂Si₅N₈: Eu²⁺ | BaₗSrₘSi₂O₆: Eu²⁺ | l + m = 2 | 31 | 0 | 0 | 0 | 69 |
| | Ca₂Si₅N₈: Eu²⁺ | BaₗSrₘSi₂O₆: Eu²⁺ | l + m = 3 | 30 | 1 | 0 | 0 | 52 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-260548, filed Oct. 7, 2008, which is hereby incorporated by reference herein in its entirety.

What is claimed is:

1. An image display apparatus that carries a panel comprising a back panel with wirings that cross each other and electron emitting devices provided in intersection portions of the wirings and a face plate with formed therein cells comprising fluorescent materials that emit red, blue, and green light, and in which gradation control is performed by varying an application time of a drive voltage that is applied to the electron emitting devices, wherein
a line selection time, which is an application time of a drive voltage that is applied to the electron emitting devices via the wirings that cross each other, is longer than 1 μs and a red fluorescent material that forms the cells emitting red light is represented by a general formula Me₂Si₅N₈:Eu²⁺ (Me is Ca or Sr).

2. The image display apparatus according to claim 1, wherein another fluorescent material that receives electrons emitted from the electron emitting devices and has light emission in a near ultraviolet region to visible region under electron beam excitation is further provided on the electron emitting devices side of the red fluorescent material.

3. The image display apparatus according to claim 2, wherein the fluorescent material that has light emission in a near ultraviolet region to visible region comprises a complex alkaline earth silicate fluorescent material represented by a general formula M1ₗM2ₘSi₂O₆:Eu²⁺ (M1, M2 are any of Ba, Sr, Ca, and Mg; 1<l+m<3).

4. The image display apparatus according to claim 3, wherein the fluorescent material that has light emission in a near ultraviolet region to visible region is CaₗMgₘSi₂O₆:Eu²⁺.

5. The image display apparatus according to claim 1, wherein the wirings that cross each other include a plurality of scanning wirings and a plurality of signal wirings that cross the plurality of scanning wirings, a modulation voltage is applied to the plurality of signal wirings synchronously with application of a selection voltage to the plurality of scanning wirings, and an application time of the selection voltage to each of the plurality of scanning wirings is equal to the application time of the drive voltage.

6. The image display apparatus according to claim 5, wherein another fluorescent material that receives electrons emitted from the electron emitting devices and has light emission in a near ultraviolet region to visible region under electron beam excitation is further provided on the electron emitting devices side of the red fluorescent material.

7. A device that carries a panel comprising a back panel with wirings and electron emitting devices provided in intersection portions of the wirings and a face plate with formed therein cells comprising a fluorescent material that emits light, and in which gradation control is performed by varying an application time of a drive voltage that is applied to the electron emitting devices, wherein
a line selection time is longer than 1 μs and the fluorescent material comprises a substance represented by a general formula Me₂Si₅N₈:Eu²⁺ (Me is Ca or Sr).

8. The device according to claim 7, wherein another fluorescent material having light emission in a near ultraviolet region to visible region under electron beam excitation is further provided on the electron emitting devices side of the substance represented by the general formula Me₂Si₅N₈:Eu²⁺ (Me is Ca or Sr).

9. The device according to claim 8, wherein the fluorescent material having light emission in a near ultraviolet region to visible region under electron beam excitation comprises a complex alkaline earth silicate fluorescent material represented by a general formula M1ₗM2ₘSi₂O₆:Eu²⁺ (M1, M2 are any of Ba, Sr, Ca, and Mg; 1<l+m<3).

10. The device according to claim 9, wherein the fluorescent material having light emission in a near ultraviolet region to visible region is CaₗMgₘSi₂O₆:Eu²⁺.

11. The device according to claim 7, wherein the wirings include a plurality of scanning wirings and a plurality of signal wirings that cross the plurality of scanning wirings, a modulation voltage is applied to the plurality of signal wirings synchronously with application of a selection voltage to the plurality of scanning wirings, and an application time of the selection voltage to each of the plurality of scanning wirings is equal to the application time of the drive voltage.

12. The device according to claim 11, wherein another fluorescent material is further provided on the electron emitting devices side of the substance represented by a general formula Me₂Si₅N₈:Eu²⁺ (Me is Ca or Sr).

13. The device according to claim 7 wherein the line selection time is an application time of a drive voltage that is applied to the electron emitting devices via the wirings.

14. The device according to claim 7, wherein the light includes red, blue, and green light.

15. A display comprising an electron emitting device and a red fluorescent material which emits red light in response to emission of the electron emitting device, wherein an application time of a drive energy to drive the electron emitting device is longer than a 1/10 luminance decay time of the red fluorescent material.

16. The display according to claim 15, wherein the red fluorescent material comprises a substance represented by a general formula Me₂Si₅N₈:Eu²⁺ (Me is selected from Ca and Sr).
